(19) United States
(12) Patent Application Publication
(10) Pub. No.: US 2026/0069106 A1
(43) Pub. Date: Mar. 12, 2026

(54) DRIVE SYSTEM FOR A FLOOR CLEANER

(71) Applicant: Dyson Technology Limited, Malmesbury, Wiltshire (GB)

(72) Inventors: Samuel Richard ATTWELL, Swindon (GB); Stuart Lloyd GENN, Swindon (GB)

(21) Appl. No.: 19/106,430

(22) PCT Filed: Aug. 11, 2023
(86) PCT No.: PCT/IB2023/058134

§ 371 Date: Feb. 25, 2025

(30) Foreign Application Priority Data
Aug. 31, 2022 (GB) 2212584.3

(51) Int. Cl. A47L 11/40; H02K 9/10

(52) U.S. Cl. CPC A47L 11/4069; A47L 11/4002; H02K 9/10

(57) ABSTRACT

A drive system for a floor cleaner includes a motor and a cooling fan longitudinally disposed with respect to one another within a longitudinally extending drive housing. The drive output of the motor is configured to drive the cooling fan via driveshaft and a drive connector which includes a fan-side connector element and a motor-side connector element. The fan-side connector element is configured to interlock with the motor-side connector element.

### TECHNICAL FIELD

The present invention relates to a drive system for a floor cleaner, as well as to a cleaner head assembly and a cleaner head comprising such a drive system, and to a floor cleaner comprising such a cleaner head.

### BACKGROUND

Wet floor cleaners with motor driven rotating mopping rollers are becoming increasingly popular. The performance of such cleaners is superior to traditional mops as the number of passes that a motor driven mop roller is able to make over a stain in any given period of time far exceeds the number of passes possible when using a traditional mop.

It is preferable for wet floor cleaners to be as light and as compact as possible to aid manoeuvrability and access to small spaces in use, and to allow easy and neat storage. However, the need for compactness can present something of a challenge for motor driven wet floor cleaners due to the need for on-board motors, cooling systems, power transmission and power supply. In addition, the use of electric motors in a wet environment presents an additional challenge due to the need to keep water away from electrical systems.

It is common for wet floor cleaners to be bumped into skirting boards or furniture when being used to clean a floor. Such impacts may damage the systems of a motor driven wet floor cleaner.

It is against this background that the present invention has been developed.

### SUMMARY

In a first aspect, the present invention provides a drive system for a floor cleaner, comprising: a motor; a cooling fan; and a longitudinally extending drive housing, wherein the motor and the cooling fan are longitudinally disposed with respect to one another within the drive housing, and wherein a drive output of the motor is configured to drive the cooling fan via a driveshaft and a drive connector, wherein the drive connector comprises a fan-side connector element and a motor-side connector element, wherein the fan-side connector element is configured to interlock with the motor-side connector element.

The present invention is advantageous because the interlocking connector element(s) help to decouple the fan from the motor thereby helping to reduce the transmission of shocks and impacts to the fan.

In some embodiments the fan-side connector element and/or the motor-side connector element comprises a resiliently deformable material. Optionally only one of the motor-side connector element, or the fan side connector element, comprises a resiliently deformable material. This further helps to absorb the energy of any shocks or impacts experienced by the floor cleaner.

The motor-side connector element may comprise one or more connection formations configured to engage with one or more corresponding connection formations in the fan side connector element. Optionally, the connector elements may each comprise one or more inter-engaging formations configured to interlock with one or more corresponding inter-engaging formations of the other connector element. The connector elements optionally comprise inter-engaging drive connection formations to provide secure transmission of rotation from the motor shaft to the fan.

Optionally, one of the connector elements comprises a plurality of grooves and the other of the connector elements comprises a plurality of protrusions corresponding to the plurality of grooves, wherein each of the plurality of protrusions is configured to interlock with one of the plurality of grooves.

In some embodiments the connector elements comprise inter-engaging drive dogs.

The cooling fan may comprise a radial flow impeller.

In one example the drive system comprises a diffuser located between the cooling fan and the motor to help evenly distribute the cooling air flow within the drive housing.

Optionally a centre of rotation of the cooling fan is offset from a central axis of the diffuser. In other words, the cooling fan can be mounted eccentrically, or non-concentrically, with the diffuser. This may be in order to align the axis of rotation of the cooling fan with the axis of rotation of the motor drive shaft, while allowing the diffuser to cover a larger area, which can improve airflow efficiency. The diffuser may be shaped to distribute the airflow as evenly as possible within the drive housing despite the non-symmetrical mounting of the fan.

The drive connector is optionally located at least partially within the longitudinal extent of the diffuser to make efficient use of available packaging space.

In a second aspect, the present invention provides an agitator head assembly for a floor cleaner comprising a drive system as described above, and an agitation member mounted for rotation about the drive assembly.

In a third aspect, the present invention provides a cleaner head for a floor cleaner comprising one or more agitator head assemblies described above mounted within a cleaner head housing.

In a fourth aspect, the present invention provides a floor cleaner comprising such a cleaner head.

Features described above in connection with the first aspect of the invention are equally applicable to the second, third and fourth aspects of the invention, and vice versa.

### BRIEF DESCRIPTION OF THE DRAWINGS

FIG. 1 shows an isometric view of a cleaner head for a wet floor cleaner;

FIG. 2 shows an isometric view of a mop assembly of the cleaner head with the mop roller shown in ghost view;

FIG. 3 shows a longitudinal cross-sectional view of a drive system of the mop assembly;

FIG. 4 shows a cross-sectional view along line A-A of FIG. 3;

FIG. 5 shows a cross-sectional view along line B-B of FIG. 3;

FIG. 6 is a partial isometric view of the drive system of FIG. 3;

FIG. 7 is another partial isometric view of the drive system of FIG. 3;

FIG. 8 shows a cross-sectional view of the fan and diffuser arrangement of the drive system;

FIG. 9 shows an exploded view of the fan and diffuser arrangement of FIG. 8;

FIG. 10a shows a longitudinal cross-sectional view of an alternative air intake to the air intake shown in FIG. 3; and

FIG. 10b shows a longitudinal cross-sectional view of a further alternative air intake to the air intake shown in FIG. 3.

### DETAILED DESCRIPTION

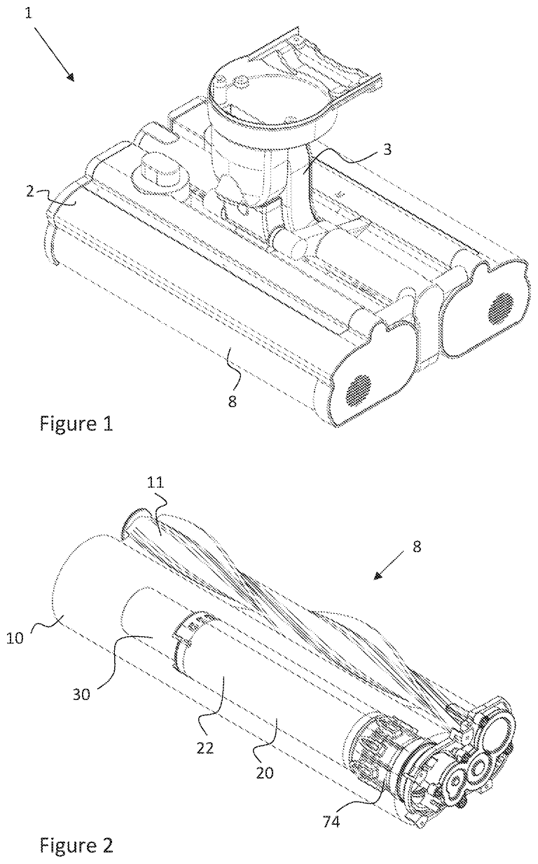

FIG. 1 shows an isometric view of a cleaner head 1 for a wet floor cleaner. In the example shown in FIG. 1, the cleaner head 1 comprises two mop assemblies 8 located within a cleaner head housing 2. Each mop assembly 8 comprises a mop roller 10, a mop cleaner 11 and a drive system 20 as will be described in greater detail below. The cleaner head housing 2 is provided will a boss 3 for connection to a handle of a wet floor cleaner.

Although the example cleaner head 1 shown in FIG. 1 comprises two mop assemblies 8, it will be understood that the cleaner head 1 may comprise only one mop assembly 8, or may comprise more than two mop assemblies 8.

Referring now to FIG. 2, the mop assembly 8 comprises a mop roller 10 (shown in ghost view) mounted for rotation on a drive system 20. A mop cleaner 11, in the form of a rotating roller or brush bar, is arranged alongside the mop roller 10. In use, the mop cleaner 11 rotates to clean the mop roller 10 of dirt and debris which has become stuck to the mop roller 10 in use. The drive system 20 is configured to rotate both the mop roller 10 and the mop cleaner 11 as will be described in greater detail below.

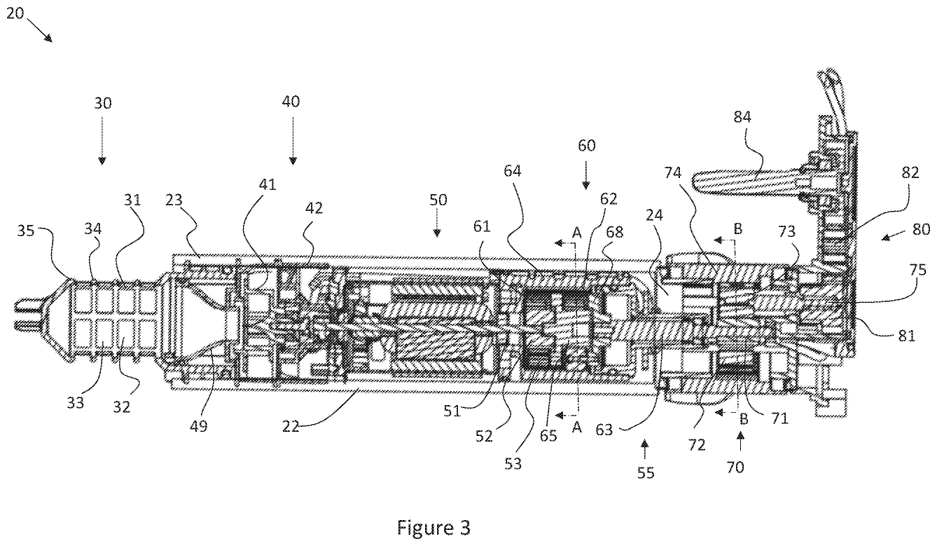

FIG. 3 shows a longitudinal cross-sectional view of the drive system 20 which comprises a tubular drive housing 22 having a first end 23 and a second end 24. An air intake 30 is located at the first end 23 of the drive housing 22, and an electric motor 50 and a planetary gear system 60 are located within the drive housing 22. The planetary gear system 60 comprises a primary reduction stage 61 and a secondary reduction stage 62. An output shaft 63 extends from the output of the planetary gear system 60 through the second end 24 of the drive housing 22.

A second planetary system 70 is located at the second end 24 of the drive housing 22. The output shaft 63 of planetary gear system 60 provides an input drive to the sun gear 71 of the second planetary system 70. Together, the planetary gear system 60 and the second planetary gear system 70 form a gear arrangement 55 of the drive system 20, with the second planetary gear system 70 forming the final reduction stage of the gear arrangement 55.

The primary reduction stage 61 of the planetary gear system 60 receives drive input to its sun gear 52 from the output shaft 51 of the electric motor 50. The output of the primary reduction stage 61 is transmitted to the sun gear 65 of the secondary reduction stage 62 via stub shafts (not shown) on which the planet gears 53 of the primary reduction stage 61 are mounted. The planet gears 53 of the primary reduction stage 61 engage between the sun gear 52 of the primary reduction stage 61 and a ring gear 64. The ring gear 64 is common to the primary and secondary reduction stages 61, 62 of the planetary gear set 60. The ring gear 64 is fixed in relation to the housing 22.

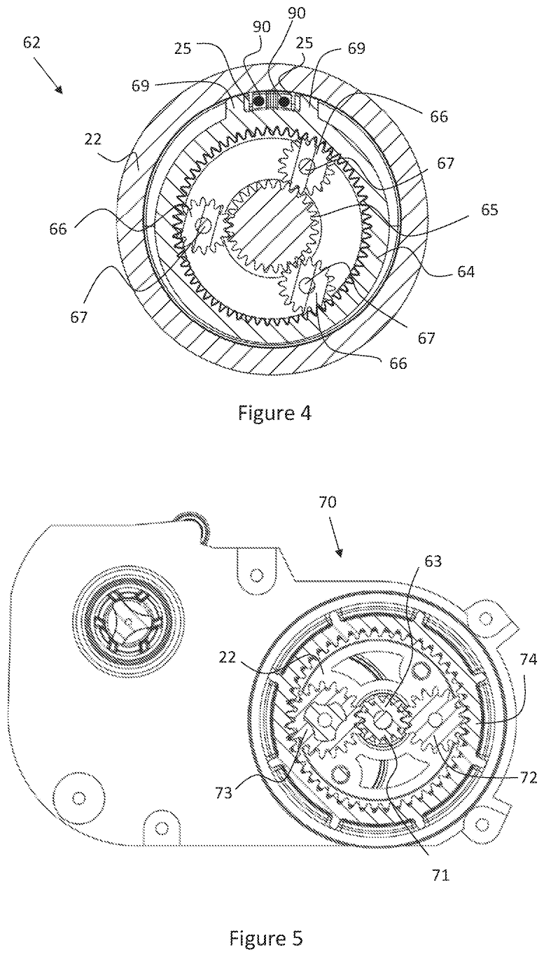

FIG. 4 is a cross-sectional view though line A-A of FIG. 3 showing the secondary reduction stage 62 of the planetary gear system 60. The drive input received by the sun gear 65 is transmitted to an output spider 68 via stub shafts 67 upon which the planet gears 66 of the secondary reduction stage 62 are mounted. The planet gears 66 of the secondary reduction stage 62 engage between the sun gear 65 of the secondary reduction stage 62 and the ring gear 64.

As best shown in FIG. 4, the planetary gear system 60 is not centred within the drive housing 22. Rather, the central drive axis of the planetary gear system 60 is offset with respect to the central axis of radial symmetry of the drive housing 22 to allow power supply wiring 90 to pass by the planetary gear system 60 to the motor 50. Ribs 69 located on the outer surface of the ring gear 64 locate the planetary gear system 60 between ribs 25 located on the interior surface of the drive housing 22. The ribs 69 define passages through which the wiring 90 passes.

FIG. 5 is a cross-sectional view though line B-B of FIG. 3 showing the second planetary gear system 70. The drive input to the second planetary gear system 70 is received by sun gear 71 and transmitted to ring gear 74 via first and second planet gears 72, 73. The ring gear 74 forms an output of the second planetary gear system 70, and hence forms an output of the gear arrangement 55. As shown in FIG. 5, the first and second planet gears 72, 73 of the second planetary gear system 70 are of different sizes to compensate for the offset of the output shaft 63 (and hence the sun gear 71) with respect to the drive housing 22. The size of the first and second planet gears 72, 73 may be stipulated in any suitable way such as by pitch circle diameter, pitch diameter or number or teeth for example.

Referring once again to FIG. 2, the mop roller 10 of the mop assembly 8 is mounted on, and driven by, the ring gear 74 of the second planetary gear system 70. The mop roller 10 extends away from the ring gear 70 such the drive housing 22 and the air intake 30 are located within the mop roller 10. In the example mop assembly 8 shown in FIG. 2, the mop roller extends beyond the end of the air intake 30. However, in other embodiments the mop roller 10 may be of any suitable length.

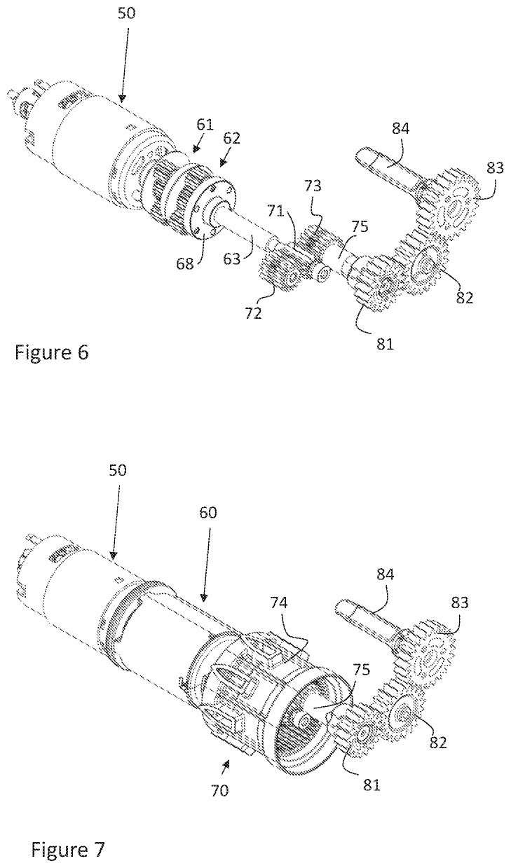

Referring now to FIG. 3, FIG. 6 and FIG. 7, the second planet gear 73 of the second planetary gear system 70 is connected to an output shaft 75 which provides drive to an input gear 81 of a gear train set 80 located outwardly of the second planetary gear system 70 with respect to the second end 24 of the housing 22. The second planet gear 73 thereby forms a further output from the gear arrangement 55. The gear train set 80 comprises the input gear 81, an idler gear 82, and an auxiliary drive gear 83. The idler gear 82 is provided so that the sense of rotation of the auxiliary drive gear 83 is the same as the sense of rotation of the input gear 81.

A drive adaptor 84 connects the auxiliary output gear 83 to the mop cleaner 11. In an alternative arrangement, the idler gear 82 may be dispensed with, or an additional idler gear may be used between the idler gear 82 and the auxiliary drive gear 83, so that the sense of rotation of the mop cleaner 11 is opposite to that of the mop roller 10 in use.

As can be seen, in this example the idler gear 82 and auxiliary drive gear 83 have fewer teeth than the input drive gear 81. This means the gear train set 80 has the effect of increasing the rotational speed of the further output, which is connected to the mop cleaner 11, compared to the rotational speed of the mop roller 10. It has been found this provides improved cleaning of the mop roller 10.

Although several reduction stages are provided in this embodiment, including primary reduction stage 61, secondary reduction stage 62 and a further reduction stage 70, in some embodiments one or both of the primary reduction stage 61 and secondary reduction stage 62 can be omitted, dependent on the capabilities of the motor and the desired rotational speed of the output.

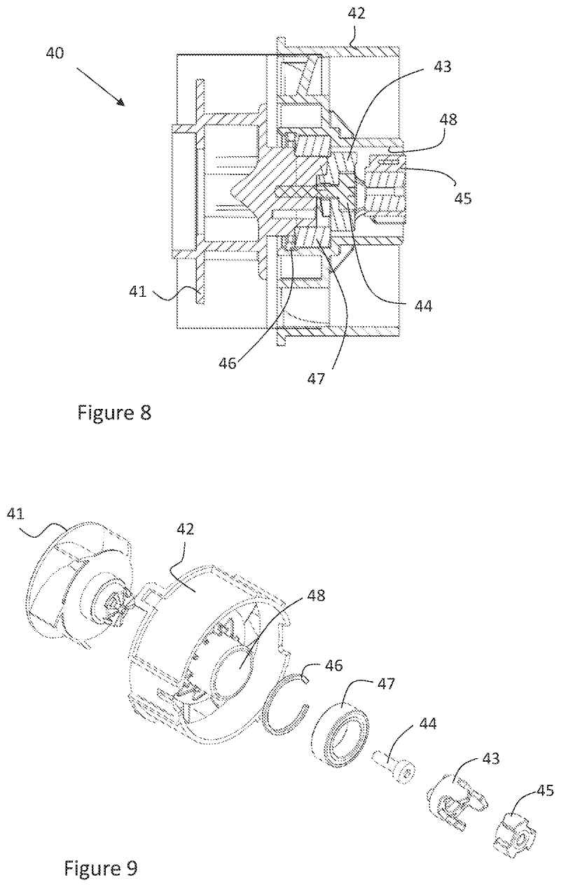

Referring now to FIG. 3, FIG. 8 and FIG. 9, the drive system 20 comprises an air intake 30 and an intake fan assembly 40. The air intake 30 is located at the first end 23 of the drive housing 22, and the intake fan assembly 40 is located within the drive housing 22 between the motor 50 and air intake 30.

The intake fan assembly 40 comprises an intake nozzle 49, a fan 41 in the form of a radial impeller 41, and a diffuser 42 which is attached to the drive housing 22. The fan 41 is operably connected to the output shaft 51 of the motor 50 via a pair of interlocking drive dog connectors 43, 45 located within a passage 48 of the diffuser 42. The drive dog 43 provide the attachment to the impeller 41 and the drive dog 45 provides the connection to the motor. The drive dog connectors 43, 45 are held in position in the passage 48 by a bearing 47 and a circlip 46. A screw 44 is provided to attach the impeller drive dog 43 to the impeller 41. The bearing 47 is sandwiched between the impeller 41 and the drive dog 43.

In use, the fan 41 is rotated by the motor 50 causing air to be drawn into the nozzle 49 via the air intake 30. The nozzle directs the air to the centre of the fan 41. Upon exit from the fan 41, the air passes through the diffuser 42 and on into the drive housing 22 to cool the motor 50.

In the example described above, the fan 41 is a radial flow impeller. However, any other suitable type of fan may be used, such as a mixed flow or axial flow impeller, or another type of fan. Depending on the type of fan used, the nozzle 49 may not be required.

The impeller side connector 43 has a plurality of protrusions (also described as fingers) to allow interlocking with the motor side connector 45. The motor side connector 45 has a plurality of grooves corresponding to the protrusions of the impeller side connector 43. The protrusions of the impeller side connector 43 engage with the grooves of the motor side connector 45. This allows the drive of the motor to be transferred to the impeller, whilst decoupling the impeller from the motor to protect the impeller from impacts or vibrations transferred from the motor mass.

Although in this case the impeller side connector 43 has protrusions that fit into grooves of the motor side connector 45, in alternative arrangements the protrusions may be provided on a motor side connector and corresponding grooves on the impeller side connector. In some embodiments protrusions may be provided on both connectors.

The distance between the fan 41 and the motor 50 may make the fan 41 vulnerable to shocks and impacts caused by the cleaner head 1 being bumped or knocked into walls or furniture in use. Such impacts may be amplified by the effective cantilevered mounting of the fan 41 on the motor drive shaft 51, leaving the fan 41 particularly susceptible to damage. Providing two interlocking drive connectors 43, 45 has the effect of decoupling the fan 41 from the motor 50, which can help stabilise the fan 41 and reduce the risk of damage to the fan 41. To alleviate this further, one or both of the connectors 43, 45 may comprise a flexible, or resiliently deformable, material, such as rubber, to absorb impacts and help reduce or prevent transmission of impact energy to the fan 41. It will be understood that the connection between the drive shaft 51 and the radial impeller 41 be made via connectors other than dog connectors, and that any other suitable type of connector may be used.

The air intake 30 comprises an elongate tubular body 31 comprising a plurality of openings 32. The openings 32 are covered by a mesh 33 to prevent ingress of dust and other small particles into the interior of the drive system 20.

The air intake 30 also comprises a plurality of outwardly extending annular fins 34 spaced along the length of the tubular body 31. In use, the annular fins 34 help to prevent water ingress into the interior of the drive system 20 by deflecting any water droplets or jets which pass through the interior of the mop roller 10 to the air intake 30. A plurality of outwardly extending protrusions 35 are located at the distal end 36 of the air intake 30 with respect to the first end 23 of the drive housing 22. The outwardly extending protrusions 35 help to support the drive system 20 in the cleaner head housing.

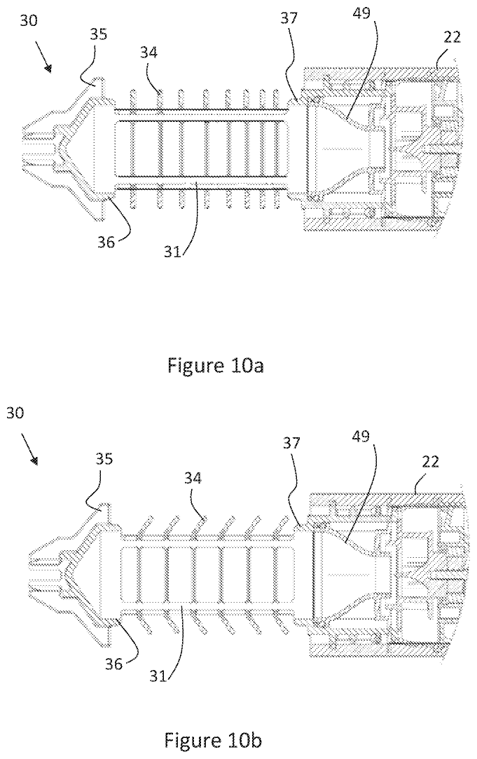

FIGS. 10a and 10b show alternative configurations for the air intake 30. In FIG. 10a, the spacing of the outwardly extending annular fins 34 varies along the length of the tubular body 31 such that the spacing between adjacent annular fins 34 at the distal end 36 of the air intake 30 is greater than the spacing between adjacent annular fins 34 at the proximal end 37 of the air intake 30. This arrangement places more water ingress protection towards the proximal end 37 of the air intake 30.

In an alternative arrangement, the spacing between adjacent annular fins 34 at the distal end 36 of the air intake 30 may be less than the spacing between adjacent annular fins 34 at the proximal end 37 of the air intake 30 to place more water ingress protection towards the distal end 36 of the air intake 30. In a further alternative arrangement, the spacing between adjacent annular fins 34 at the ends 36, 37 of the air intake 30 may be less than the spacing between adjacent annular fins 34 towards the centre of the air intake 30, or vice versa, to place more water ingress protection towards the centre or ends of the air intake 30. The exact positioning of the annular fins 34 may tuned to best suit any particular mop assembly 8.

FIG. 10b shows a further alternative arrangement for the air intake 30 in which the annular fins 34 are angled with respect to the tubular body 31. This arrangement provides more water ingress protection for water droplets and jets with a steeper angle of incidence with respect to the axis of the air inlet 30.

In a further alternative arrangement for the air intake 30 (not illustrated), the annular fins 34 vary in length along the axis of the tubular body 31. In one example the fins 34 at the distal end 36 of the air intake 30 are longer than the annular fins 34 at the proximal end 37 of the air intake 30 to place more water ingress protection towards the distal end 36 of the air intake 30. This arrangement places more water ingress protection towards the distal end 36 of the air intake 30.

In another example the fins 34 at the proximal end 37 of the air intake 30 are longer than the annular fins 34 at the distal end 36 of the air intake 30 to place more water ingress protection towards the proximal end 37 of the air intake 30.

It will be appreciated that the spacing between the angled fins 34 shown in FIG. 10b may be varied in the same way as described above with respect to FIG. 10a and its described alternatives.

1. A drive system for a floor cleaner, comprising:
a motor;
a cooling fan; and
a longitudinally extending drive housing,
wherein the motor and the cooling fan are longitudinally disposed with respect to one another within the drive housing, and wherein a drive output of the motor is configured to drive the cooling fan via a driveshaft and a drive connector, wherein the drive connector comprises a fan-side connector element and a motor-side connector element, wherein the fan-side connector element is configured to interlock with the motor-side connector element.

2. A drive system according to claim 1, wherein the fan-side connector element and/or the motor-side connector element comprises a resiliently deformable material.

3. A drive system according to claim 2, wherein only the motor-side connector element comprises a resiliently deformable material.

4. A drive system according to claim 1, wherein the connector elements each comprise one or more inter-engaging formations configured to interlock with one or more corresponding inter-engaging formations of the other connector element.

5. A drive system according to claim 4, wherein one of the connector elements comprises a plurality of grooves and the other of the connector elements comprises a plurality of protrusions corresponding to the plurality of grooves, wherein each of the plurality of protrusions is configured to interlock with one of the plurality of grooves.

6. A drive system according to claim 1, wherein the connector elements comprise inter-engaging drive dogs.

7. A drive system according to claim 1, wherein the cooling fan comprises a radial flow impeller.

8. A drive system according to claim 1, comprising a diffuser located between the cooling fan and the motor.

9. A drive system according to claim 8, wherein a centre of rotation of the cooling fan is offset from a central axis of the diffuser.

10. A drive system according to claim 8, wherein the drive connector is located at least partially within the longitudinal extent of the diffuser.

11. An agitator head assembly for a floor cleaner comprising a drive system according to claim 1, and an agitation member mounted for rotation about the drive system.

12. A cleaner head for a floor cleaner comprising one or more agitator head assemblies according to claim 11 mounted within a cleaner head housing.

13. A floor cleaner comprising the cleaner head according to claim 12.
